(19) United States
(12) Patent Application Publication
(10) Pub. No.: US 2007/0174134 A1
(43) Pub. Date: Jul. 26, 2007

(54) Method and system for providing gifts to a person

(75) Inventor: Phillip Kleweno, Los Angeles, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Teleflora LLC

(21) Appl. No.: 11/342,341

(22) Filed: Jan. 26, 2006

(51) Int. Cl. G06Q 30/00

(52) U.S. Cl. 705/26

(57) ABSTRACT

Described herein is a method for providing flower giving services to a flower giver using a computer network. The method includes the steps of providing a computer network, providing an internet website operatively associated with the computer network, providing the flower giver with means for ordering a number of flowers, prompting the gift giver to enter delivery information pertaining to a flower receiver and delivering the number of flowers to the flower receiver. The number of flowers corresponds to a number associated with an event, such as a birthday or anniversary. The delivery information is stored in a database operatively connected to the internet website.

### FIELD OF THE INVENTION

The present invention relates to a method and system for providing gifts to a person.

### BACKGROUND OF THE INVENTION

It is customary to give a person a gift for his or her birthday or other special events. People often have a difficult time figuring out what gift to give. Other times people do not have enough time to select a good gift or any gift at all. Thus, a need exists for a method and system for providing gifts to a person that addresses the foregoing problems.

### SUMMARY OF THE PREFERRED EMBODIMENTS

In accordance with one aspect of the present invention, there is provided a method for providing gifts to a person. The method includes the steps of choosing an event having a number associated with it, logging on to a webpage, and selecting a number of gifts to be delivered to a person. The number associated with the event corresponds to the number of gifts to be delivered.

In accordance with another aspect of the present invention, there is provided a method for providing gift giving services to a gift giver using a computer network. The method includes the steps of providing a computer network, providing the gift giver with means for ordering a number of gifts, and delivering the number of gifts to a gift receiver. The number of gifts corresponds to a number associated with an event.

In accordance with another aspect of the present invention, there is provided a method for providing flower giving services to a flower giver using a computer network. The method includes the steps of providing a computer network, providing an internet website operatively associated with the computer network, providing the flower giver with means for ordering a number of flowers, prompting the gift giver to enter delivery information pertaining to a flower receiver and delivering the number of flowers to the flower receiver. The number of flowers corresponds to a number associated with an event, such as a birthday or anniversary. The delivery information is stored in a database operatively connected to the internet website.

In accordance with yet another aspect of the present invention, there is provided a method for providing gifts to a person. The method includes the steps of delivering a first number of gifts to the person on the person's birthday in a first year, and delivering a second number of gifts to the person on the person's birthday in a second year. The first number of gifts given corresponds to the person's age during the first year and the second number of gifts given corresponds to the person's age during the second year.

In accordance with yet another aspect of the present invention, there is provided a method for providing gifts to a person. The method includes the steps of providing a database of gift receiver information pertaining to one or more gift receivers, selectively retrieving from the database the gift receiver information pertaining to a first gift receiver on the first gift receiver's birthday in a first year, and delivering a number of gifts to the first gift receiver on the first gift receiver's birthday in the first year. The gift receiver information includes identification, birthday and delivery information for the one or more gift receivers. The number of gifts corresponds to the first gift receiver's age during the first year.

### BRIEF DESCRIPTION OF THE DRAWINGS

The invention may be more readily understood by referring to the accompanying drawings in which:

FIG. 1 is block diagram of a gifting system configured in accordance with a preferred embodiment of the present invention;

FIG. 2 is a block diagram of a computer system that may be used for implementing the gifting system of FIG. 1, configured in accordance with a preferred embodiment of the present invention;

FIG. 3 is a network diagram illustrating a network of computer systems that may be used for implementing the gifting system of FIG. 1, configured in accordance with a preferred embodiment of the present invention;

FIG. 4 to FIG. 9 are a series of screenshots illustrating an example of the gifting system of FIG. 1, configured in accordance with a preferred embodiment of the present invention;

FIG. 10 is a depiction of a user screen for showing a database of gift receiver information in accordance with a preferred embodiment of the present invention; and

FIG. 11 is a depiction of a user screen showing the gift receivers who will be delivered flowers on a certain day in accordance with a preferred embodiment of the present invention.

### DETAILED DESCRIPTION OF THE PREFERRED EMBODIMENTS

According to the present invention, a method and system of providing gifts to a person is provided. In the preferred embodiment, the present invention includes providing a number of gifts to a person (also referred to herein as a gift receiver) based on an event that has a number associated with it. The number of gifts provided to the person corresponds to a number associated with the event. For example, in one preferred embodiment of the present invention, a person is given sixteen flowers for her sixteenth birthday or twelve flowers on her twelfth anniversary. As used herein, anniversary refers to the recurring date of a past event. The recurrence may be annually, monthly or weekly. The anniversary may refer to any event, for example, a wedding, the date a couple started dating, the date of graduation, the date someone was born, and the like.

For exemplary purposes only, described hereinbelow is a preferred embodiment wherein the method and system of providing gifts to a person is used to provide flowers. However, this is not a limitation on the present invention. It will be understood that the method and system can be used to provide any type of gift, such as clothes, jewelry, money, collectibles, etc.

The method and system for providing flowers to a person can be implemented using a computer, computer network or the like. Preferably, a website is associated with the computer network. In a preferred embodiment, the method can be described as follows: A gift giver (or, in this case, a flower giver) logs onto the website. The website provides the gift giver with means for ordering a number of flowers. The number of flowers corresponds to a number associated with an event, such as the gift receiver's birthday. The gift giver is then prompted to enter delivery information pertaining to the gift receiver. The delivery information is stored in a database operatively connected to the internet website. The flowers are then delivered to the gift receiver (or, in this case, flower receiver).

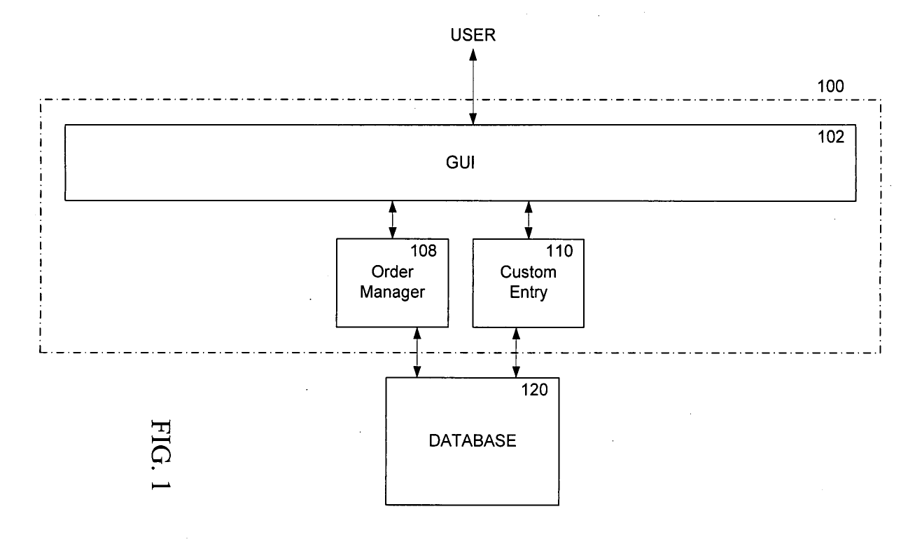

FIG. 1 is a block diagram of a flower ordering system 100 configured in accordance with one preferred embodiment of the present invention, including a graphical user interface (GUI) 102 coupled to an order manager 108 and a custom entry module 110. GUI 102 provides a user with access to the information stored in a database 120 using the functionality provided by order manager 108 and a custom entry module 110. As further described below, in one preferred embodiment, the database 120 stores information in one or more related databases that are logically grouped by predetermined areas. These areas may be, for example, gift receiver information, delivery information, billing information, gift giver information, message information, types of flowers, etc. As used herein, the term “database” should be understood to cover reference to a single database or a collection of databases. Thus, in one preferred embodiment, the database 120 includes a billing information database, a gift receiver database, a gift giver database, a custom order entry database, and a delivery information database. In other embodiments, information may be stored or arranged using a variety of data storage software and hardware techniques known to those of ordinary skill in the art in database programming. For example, one database system that may be used with the present invention is the SQL Server™ system as offered by Microsoft Corp. Other data storage systems, such as those based on Oracle Database™ products offered by Oracle Corporation or the MySQL™ database server offered by MySQL AB, may also be used. These data storage systems run on a variety of hardware platforms, including those based on the microprocessors offered by Advanced Micro Devices™, Inc., or Intel™ Corp.

As noted above, the database 120 is preferably accessible by the functionality provided by the order manager 108 and the custom entry module 110 in the flower ordering system 100. The user accesses the functionality of 108 and 110 through the GUI 102, as described further herein, which is described through a series of exemplary screenshots of what a user would see on a preferred computer display.

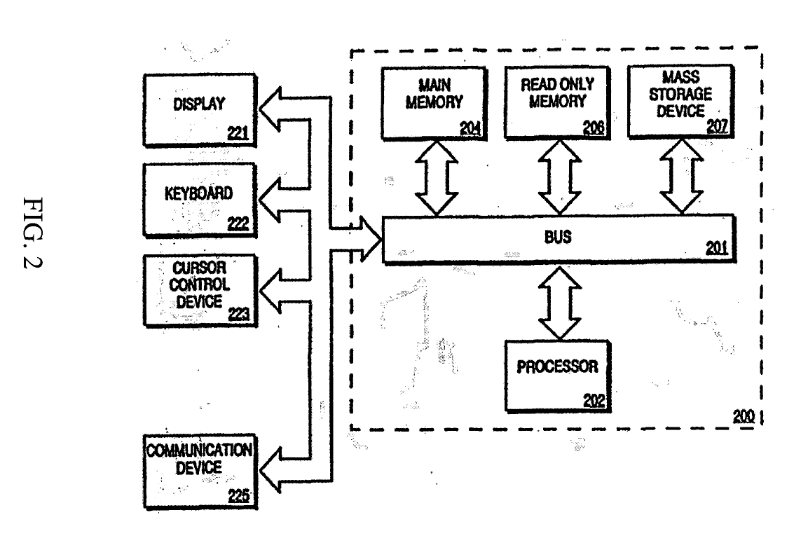

FIG. 2 illustrates an example of a computer system 200 in which the features of the present invention may be implemented. The computer system 200 includes a bus 201 for communicating information between the components in the computer system 200, and a processor 202 coupled with the bus 201 for executing software code, or instructions, and processing information. The computer system 200 further comprises a main memory 204, which may be implemented using random access memory (RAM) and/or other random memory storage device, coupled to the bus 201 for storing information and instructions to be executed by the processor 202. The main memory 204 also may be used for storing temporary variables or other intermediate information during execution of instructions by the processor 202. The computer system 200 also includes a read only memory (ROM) 206 and/or other static storage device coupled to the bus 201 for storing static information and instructions for processor 202.

Further, a mass storage device 207, such as a magnetic disk drive and/or or a optical disk drive, may be coupled to the computer system 200 for storing information and instructions. The computer system 200 can also be coupled via bus 201 to a display device 221, such as a cathode ray tube (CRT) or a liquid crystal display (LCD), for displaying information to a user so that, for example, graphical or textual information may be presented to the user on the display device 221. Typically, an alphanumeric input device 222, including alphanumeric and other keys is coupled to the bus 201 for communicating information and/or command the user can selections to the processor 202. Another type of user input device show in the figure is a cursor control device 223, such as a conventional mouse, touch mouse, trackball, track pad or other type of cursor direction keys for communicating direction information and command selection to the processor 202 and for controlling movement of a cursor on the display 221. Although not illustrated, the computer system 200 may optionally include video, camera, speakers, sound card, and many other conventional multimedia options. Various types of input devices, including, but not limited to the input devices described herein unless otherwise noted, allow the user to provide command or input to the computer system 200. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. A communication device 225 is also coupled to the bus 201 for accessing other computer systems, as described below. The communication device 225 may include a modem, a network interface card, or other well-known interface devices, such as those used for interfacing with Ethernet, Token-ring, or other types of networks. In any event, in this manner, the computer system 200 may be coupled to a number of other computer systems via a network infrastructure such as the infrastructure illustrated and described herein.

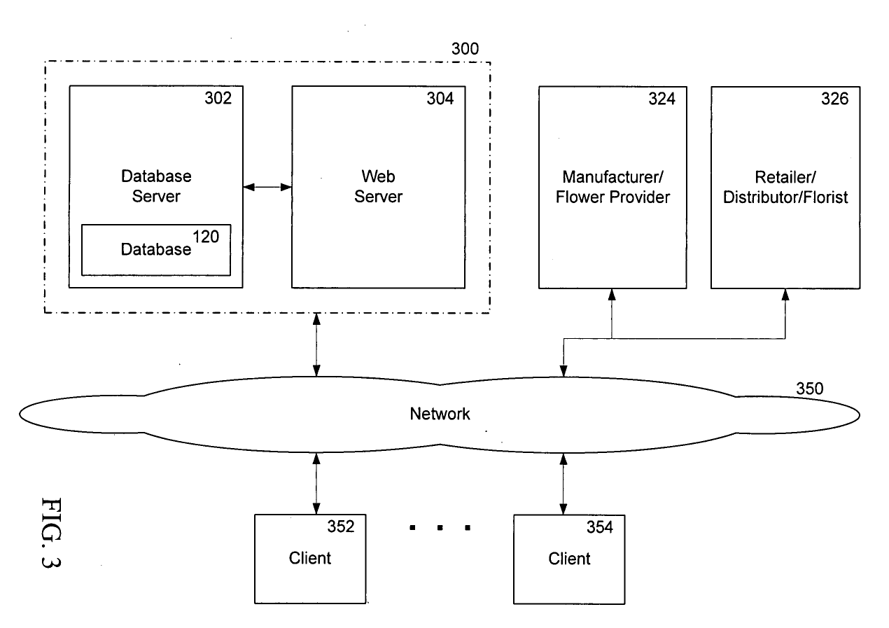

FIG. 3 illustrates a computer network including a server system 300 having a database server 302 for storing a database 120 and a web server 304 that stores the instructions necessary to access and present the information from, as well as store information into, the database 120. The user, using a client computer such as a client 352 and a client 354, accesses server system 300 through a network 350. Other systems, such as those belonging to a manufacturer/flower provider 324 or a retailer/distributor/florist 326, may also be coupled to the server system 300. In the illustrated embodiment, the network 350 represents a variety of networks that may include one or more local area networks as well as wide area networks. The functionality provided by the database server 302, the web server 304, the client 352 and the client 354, as well as by the computer systems operated by the manufacturer/flower provider 324 and retailer/distributor/florist 326 may be implemented using a computer system having the characteristics of the computer system 200 described herein. It should be noted, however, that the specific implementation of the computer system or systems used to describe the present invention is not to be limiting unless otherwise specifically noted. For example, the functionality provided by the database server 302 and the web server 304 may be offered by one computer system. Further, the functionality provided by the database server 302 and 304 may be redistributed over several computers.

As described above, the user may interact with the information stored in the database 120 through the GUI 102. In the following description, the GUI 102 is implemented using one or more web pages (which may be referred to as “pages,” “screens,” or “forms”) provided by the web server 304 accessible by the user using any Internet web browser software, such as the Internet Explorer™ browser provided by Microsoft Corp., on a client computer such as the client 352. In another embodiment, one or more custom software programs can be created to implement the system described herein. Of course, the web server 304 may itself have browser software installed on it so as to be accessed by the user. Further, throughout the description of the various embodiments of the invention herein, references are made to the user performing such actions as selecting buttons or clicking on, executing searches or updates on the database 120. In one preferred embodiment, these requests are generated by the user interacting with the browser. For example, one or more pages described herein may be forms that include fields in which the user may type in such data or select a form interface (e.g., a drop down menu, a radio button selection, etc. Once the user has provided such data, the user may select a button or link on the page to request an update of the database 120 with the information. The browser will send the web server 304 a link that includes the information being sent as well as the request to update the database 120. Depending on the browser being used, the user may need to reload the page being viewed so as to “refresh” the view of the page. In one preferred embodiment, there are two ways to refresh the view: (1) with the refresh feature provided by the user's browser, or (2) a refresh button provided on the page. In one preferred embodiment, the refresh button is displayed as an icon. Either selection will request the web server 304 to send the updated page so that the browser may refresh the page.

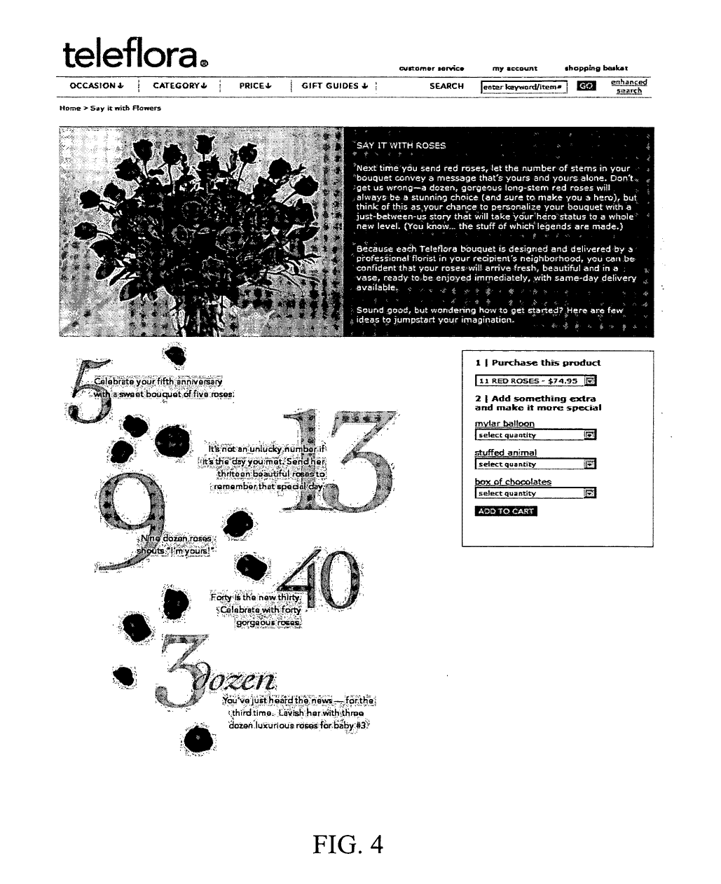

FIGS. 4-9 show screens from an exemplary flower ordering system 100 website implementing the method for providing a person with gifts. Techniques for programming computers to generate such screens are known. Any number of screen designs, layouts and sequences can be used without departing from the scope or spirit of the present invention. FIG. 4 illustrates a screenshot of a primary homepage of the flower ordering system 100. On the right side of the page is a drop down box where the gift giver can select the number of flowers that they want sent to the gift receiver. In the example given in FIG. 4 (and in the remainder of the figures) the gift giver is giving eleven red roses to the gift receiver for their eleventh anniversary. On the bottom left of the page are a number of examples of other events with numbers associated with them for which flowers can be sent.

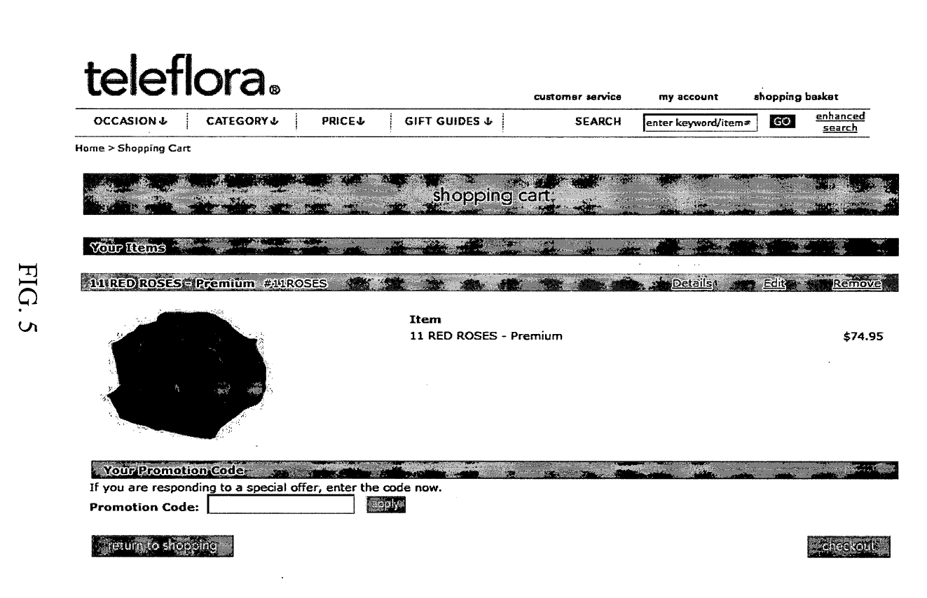

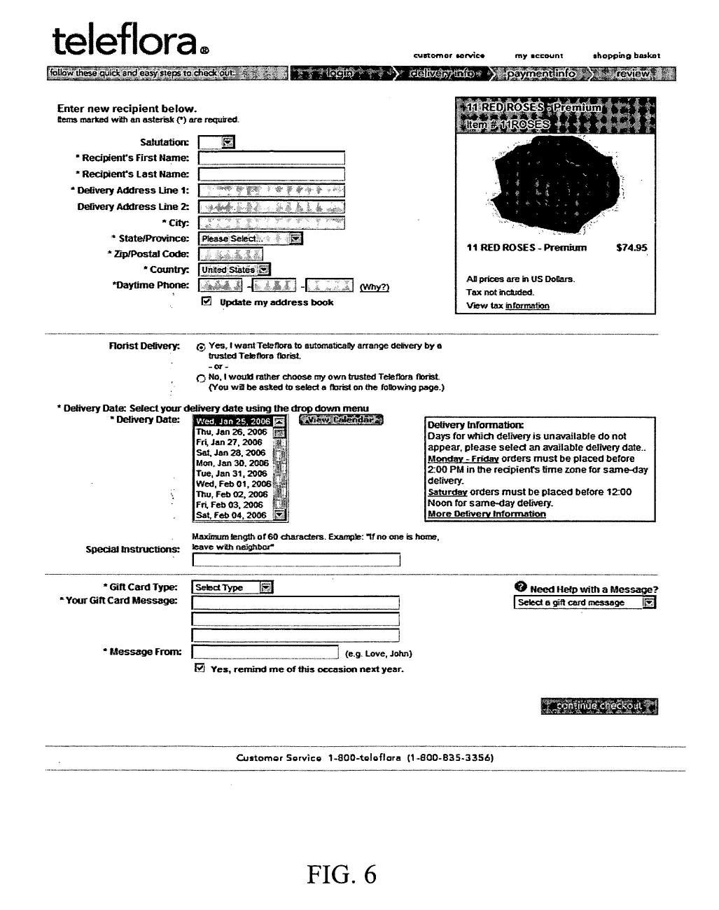

FIG. 5 shows a sample shopping cart to which the eleven red roses have been added. After clicking on “checkout,” the gift giver is taken to the screen shown in FIG. 6. On this page the gift giver enters identification and delivery information about the gift receiver, such as the gift receiver's name, address, and phone number. They also can choose the delivery date and florist and enter a message to be included on the gift card sent with the flowers. After filling in the appropriate fields, the gift giver clicks on “continue checkout.” If the gift giver is a new customer they will also have to enter payment information, such as a credit card number, billing address, etc. If the gift giver has used the site before, they may be prompted to enter a username and/or password to log in. The gift giver's payment information may be stored in the database 120 or another database. If this is the case, the gift giver may not have to re-enter the payment information for this purchase.

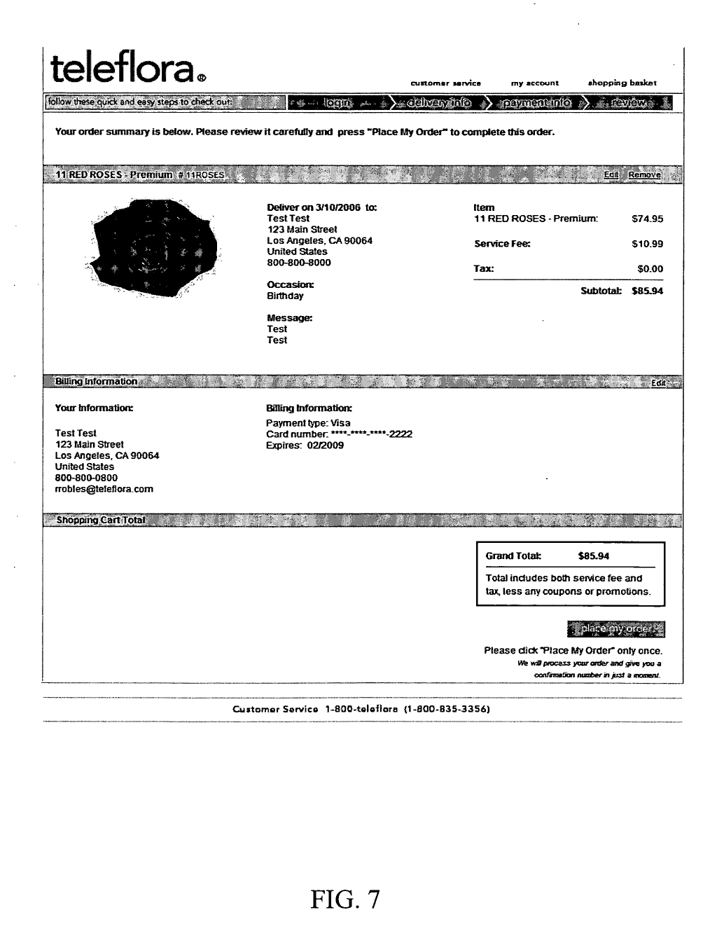

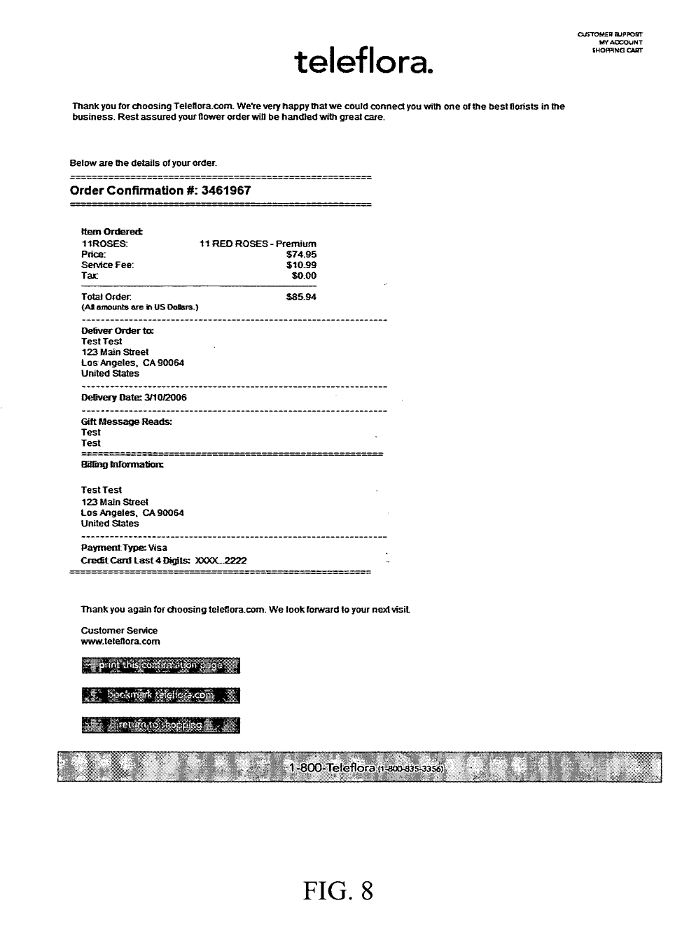

FIG. 7 shows an order summary page. This page shows, for example, the delivery date and address, the number of roses purchased, a total price and the gift giver's billing/payment information. To complete the transaction, the gift giver clicks on “place my order,” and is taken to the order confirmation screen shown in FIG. 8.

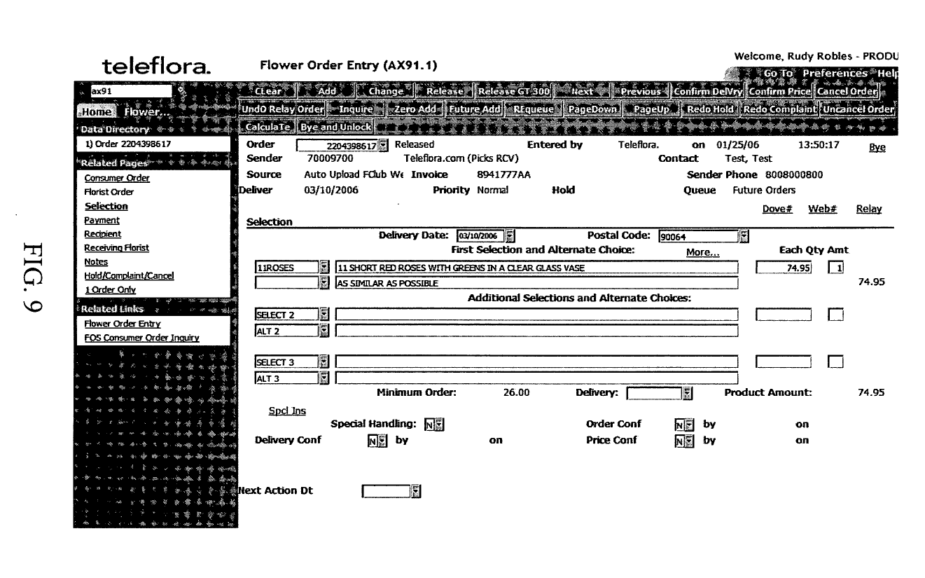

In a preferred embodiment, once the customer or gift giver has placed the order, the order is manually entered into a system that then generates an order to be filled by an individual florist. FIG. 9 shows a screen where the custom flower order is being entered.

In one preferred embodiment, the information on the page, including the available number and types of flowers that can be ordered, the price, and any additional products that can be ordered, is manually programmed. In this embodiment, each new type of custom gift requires a new web page to be created. In another embodiment, the information for each custom gift is placed into the database 120, which will allow for the dynamic generation of each page. In yet another embodiment, portions of the information for each custom gift may be retrieved from the database 120, and other portions may be manually programmed. For example, the available number of stems of flowers that may be ordered is manually programmed, while the description of the flower and the prices may be retrieved from database 120. In yet another embodiment, portions of the information for each custom gift may be retrieved from the database 120, and other portions may be generated dynamically by custom programming when the page is being created. For example, the available number of stems of flowers that may be ordered can range from 1 to 100, and the programming can generate a pull-down menu GUI with these entries.

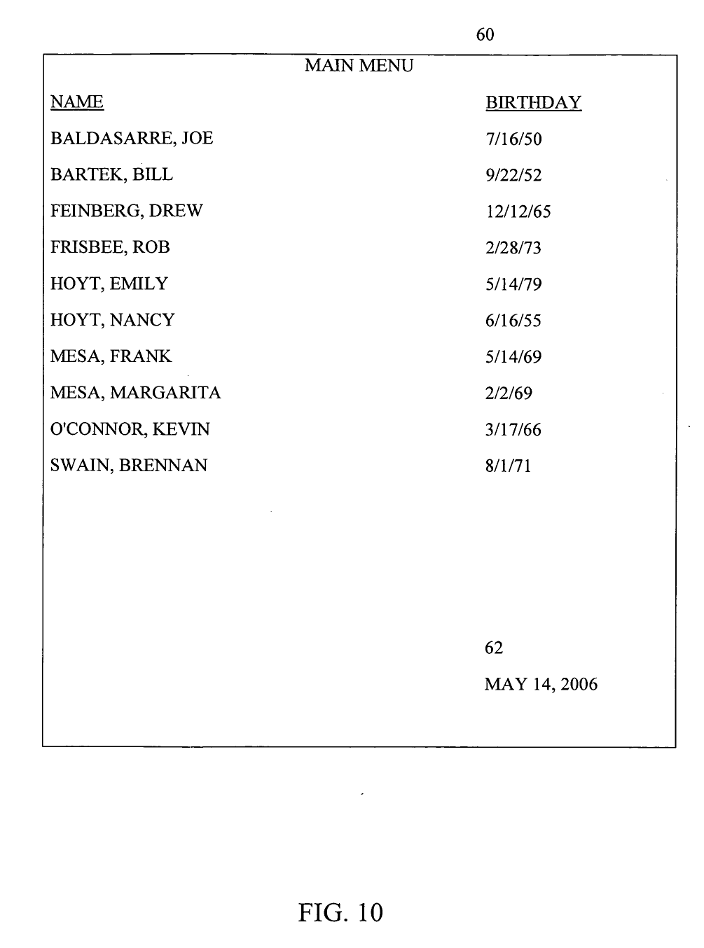

FIGS. 10-12 show a second embodiment of the present invention. In general terms, the second embodiment of the present invention includes providing a number of gifts to a person on the person's birthday. The number of gifts provided to the person corresponds to the person's age. For example, a person is given sixteen flowers for her sixteenth birthday, seventeen flowers for her seventeenth birthday, eighteen flowers for her eighteenth birthday, and so on.

Similar to the description above, this embodiment can be implemented using a computer, computer network or the like. In this embodiment, a database of gift receivers is provided. This database has been populated by gift givers entering information about the gift receivers in a manner similar to the information entry described above. The database contains personal information about the gift receivers, such as identification, birthday and delivery information. Identification information may include the person's name, nickname, username, e-mail address or the like. The delivery information may include the person's home or business address or another address where the flowers should be delivered. The database may also include personal information about the gift giver and/or information relating to a message that will be included with the flowers when they are delivered. All of the information relating to the gift receiver is referred to herein as gift receiver information.

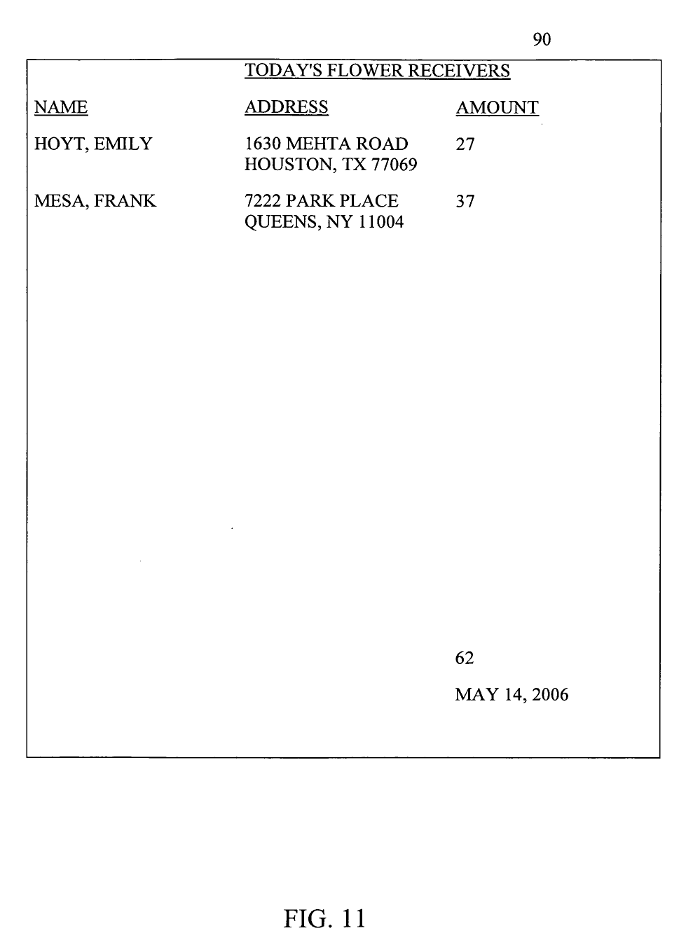

Preferably, the database is operatively coupled to a computer network 350, as best seen in FIG. 3. In a preferred embodiment, selected information from the database of gift receiver information is displayed on a computer terminal using a series of user screens, such as those shown in FIGS. 10-11. Techniques for programming computers to generate such screens are known. Any number of screen designs, layouts and sequences can be used without departing from the scope or spirit of the present invention. It is preferred that the database of gift receiver information is updated at regular intervals. For example, the database is updated on a daily basis.

FIG. 10 is a user screen displaying a main menu 60 for accessing the database of gift receiver information. The main menu 60 includes the gift receivers stored in the database and displays the gift receivers name and birthday. The date stamp 62 indicates the current date of the display.

FIG. 11 is a user screen displaying another menu 90 showing the gift receivers to whom flowers have to be delivered that day. For example, it can be seen in FIG. 10, that Emily Hoyt and Frank Mesa have birthdays on May 14. It can be seen in the lower right hand corner that the present date 62 is May 14, 2006. Accordingly, menu 90 includes Emily Hoyt and Frank Mesa and how many flowers that have to be delivered to them based on their age (twenty seven and thirty seven, respectively).

In a preferred embodiment, the gift receiver receives a number of flowers corresponding to his/her age on his/her birthday for the remainder of his/her life. In another embodiment, the gift giver can choose to have the gift receiver receive a number of flowers corresponding to his/her age on his/her birthday every year for a predetermined number of years.

As an example, if a person wanted to give his wife flowers for her twenty fifth birthday he can log on to, for example, Teleflora.com, and enter the appropriate information to purchase the flowers under the “flowers for life” program. The wife would then have twenty five flowers delivered on her twenty-fifth birthday, twenty six flowers delivered on her twenty-sixth birthday, twenty seven flowers delivered on her twenty-seventh birthday, and so on.

The foregoing embodiments are merely examples of the present invention. Those skilled in the art may make numerous uses of, and departures from, such embodiments without departing from the spirit and the scope of the present invention. Accordingly, the scope of the present invention is not to be limited to or defined by such embodiments in any way, but rather, is defined solely by the following claims.

What is claimed is:

1. A method for providing gifts to a person, comprising:
a. choosing an event having a number associated with it,
b. logging on to a webpage, and
c. selecting a number of gifts to be delivered to a person, wherein the number associated with the event corresponds to the number of gifts to be delivered.

2. The method of claim 1 further comprising the step of entering delivery information about the gift receiver.

3. A method for providing gift giving services to a gift giver using a computer network, comprising:
a. providing a computer network,
b. providing the gift giver with means for ordering a number of gifts, wherein the number of gifts corresponds to a number associated with an event, and
c. delivering the number of gifts to a gift receiver.

4. The method of claim 3 further comprising the step of prompting the gift giver to enter delivery information pertaining to the gift receiver.

5. The method of claim 4 wherein the delivery information is stored in a database.

6. The method of claim 5 wherein an internet website is operatively coupled to the database.

7. The method of claim 3 wherein the gifts are flowers.

8. The method of claim 3 wherein the event is chosen from the group containing birthday and anniversary.

9. A method for providing flower giving services to a flower giver using a computer network, comprising:
a. providing a computer network,
b. providing an internet website operatively associated with the computer network
c. providing the flower giver with means for ordering a number of flowers, wherein the number of flowers corresponds to a number associated with an event chosen from the group containing birthday and anniversary,
d. prompting the gift giver to enter delivery information pertaining to a flower receiver, wherein the delivery information is stored in a database operatively connected to the internet website; and
e. delivering the number of flowers to the flower receiver.

10. A method for providing gifts to a person, comprising:
a. delivering a first number of gifts to the person on the person's birthday in a first year, wherein the first number of gifts corresponds to the person's age during the first year, and
b. delivering a second number of gifts to the person on the person's birthday in a second year, wherein the second number of gifts corresponds to the person's age during the second year.

11. The method of claim 10 wherein the method further includes the step of continuing to deliver a number of gifts corresponding to the person's age on the person's birthday each year for a predetermined amount of time.

12. The method of claim 10 wherein the method further includes the step of continuing to deliver a number of gifts corresponding to the person's age on the person's birthday each year for the remainder of the person's life.

13. The method of claim 10 wherein the gifts are of the same type.

14. The method of claim 10 wherein the gifts are flowers.

15. A method for providing gifts to a person, comprising:
a. providing a database of gift receiver information, the gift receiver information pertaining to one or more gift receivers, wherein the gift receiver information includes identification, birthday and delivery information for the one or more gift receivers,
b. selectively retrieving from the database the gift receiver information pertaining to a first gift receiver on the first gift receiver's birthday in a first year,
c. delivering a number of gifts to the first gift receiver on the first gift receiver's birthday in the first year, wherein the number of gifts corresponds to the first gift receiver's age during the first year.

16. The method of claim 15 further comprising the steps of
a. selectively retrieving from the database the gift receiver information pertaining to the first gift receiver on the first gift receiver's birthday in a second year, and
b. delivering a number of gifts to the first gift receiver on the first gift receiver's birthday in the second year, wherein the number of gifts corresponds to the first gift receiver's age during the second year.

17. The method of claim 16 further comprising the steps of
a. selectively retrieving from the database the gift receiver information pertaining to a second gift receiver on the second gift receiver's birthday in the first year,
b. delivering a number of gifts to the second gift receiver on the second gift receiver's birthday in the first year, wherein the number of gifts corresponds to the second gift receiver's age during the first year.

18. The method of claim 17 further comprising the steps of
a. selectively retrieving from the database the gift receiver information pertaining to the first gift receiver on the first gift receiver's birthday in a second year,
b. delivering a number of gifts to the second gift receiver on the second gift receiver's birthday in a second year, wherein the number of gifts corresponds to the second gift receiver's age during the second year.

19. The method of claim 16 further comprising the steps of
a. selectively retrieving from the database the gift receiver information pertaining to the first gift receiver on the first gift receiver's birthday every year for a predetermined number of years,
b. delivering a number of gifts to the first gift receiver on the first gift receiver's birthday every year for the predetermined number of years, wherein the number of gifts corresponds to the first gift receiver's age during the year in which the number of gifts are being delivered.

20. The method of claim 16 further comprising the steps of
a. selectively retrieving from the database the gift receiver information pertaining to the first gift receiver on the first gift receiver's birthday every year for the remainder of the first gift receiver's life,
b. delivering a number of gifts to the first gift receiver on the first gift receiver's birthday every year for the remainder of the first gift receiver's life, wherein the number of gifts corresponds to the first gift receiver's age during the year in which the number of gifts are being delivered.
